(19) United States
(12) Patent Application Publication
(10) Pub. No.: US 2024/0149481 A1
(43) Pub. Date: May 9, 2024

(54) SLICING MACHINE WITH PRODUCT PARAMETER ANALYSIS APPARATUS

(71) Applicant: MULTIVAC SEPP HAGGENMUELLER SE & CO. KG, Wolfertschwenden (DE)

(72) Inventor: Dominik MARX, Giessen (DE)

(73) Assignee: MULTIVAC SEPP HAGGENMUELLER SE & CO. KG, Wolfertschwenden (DE)

(21) Appl. No.: 18/387,198

(22) Filed: Nov. 6, 2023

(30) Foreign Application Priority Data
Nov. 7, 2022 (DE) 102022129280.0

(51) Int. Cl. B26D 5/00; B26D 7/01; B26D 7/32

(52) U.S. Cl. CPC B26D 5/00; B26D 7/01; B26D 7/32; B26D 2007/011; B26D 2007/013; B26D 2210/02

(57) ABSTRACT

A slicing machine for slicing a product calibre into slices and producing shingled or stacked portions from the slices includes a slicing unit, a feeding unit for feeding at least one calibre to the slicing unit along a feeding direction, a discharge unit for discharging the slices or the portions in a direction of travel of the machine, and a gripper movable along the feeding direction. The gripper includes a product parameter detection apparatus configured to detect at least one product parameter of the calibre of product held by the gripper. The product parameter detection apparatus is configured to communicate with a product parameter analysis apparatus configured to store product parameters detected by the product parameter detection apparatus and/or to process them into a processing result.

### CROSS-REFERENCE TO RELATED APPLICATION

This application claims foreign priority benefits under 35 U.S.C. § 119(a)-(d) to German patent application number DE 102022129280.0, filed Nov. 7, 2022, which is incorporated by reference in its entirety.

### TECHNICAL FIELD

The disclosure relates to slicing machines, in particular “slicers”, with which strands of an only slightly compressible product such as sausage or cheese are sliced in the food industry. The disclosure further relates to a method of operating such a slicing machine.

### BACKGROUND

Since these strands can be produced with a cross-section that retains its shape and dimensions well over its length, i.e. substantially constant, they are called product calibre.

In most cases, several product calibres arranged parallel to one another on individual tracks are cut open at the same time by the same knife, which moves in a transverse direction to the longitudinal direction of the product calibres, cutting off one slice at a time in one passage.

The product calibres are pushed forward by a feed conveyor of a feeding unit in the direction of the knife of the slicing unit, usually on an obliquely downwardly directed feed conveyor, and guided in each case through the product openings of a plate-shaped, so-called cutting frame, at the front end of which the part of the product calibre projecting beyond it is cut off as a slice by the knife directly in front of the slicing frame.

The slices usually fall onto a first discharge conveyor, the “portioning bel”, as part of a discharge unit, by means of which the individual separated slices are also collected into shingled or stacked portions on the portioning belt and transported away for further processing.

In order to guarantee the quality of the sliced slices and thus of the portions throughout, a number of product parameters, for example a temperature, of the product calibre must usually be taken into account and monitored accordingly. In addition to temperature, however, there are a number of other product parameters, such as product consistency, which can significantly influence the quality and texture of the slices or portions.

In principle, the product parameters can be monitored randomly or manually by an operator of the slicing machine, but this is often not sufficient to ensure consistently high quality, particularly not 100%.

Although it is certainly conceivable to monitor the product parameters automatically by means of a large number of sensors on the slicing machine, the susceptibility of the slicing machine to any malfunctions that may be triggered by sensor malfunctions or similar, as well as the ease of maintenance of the slicing machine, should not be unreasonably influenced by this.

It is also desirable that the slicing machine is not only capable of detecting and/or monitoring the product parameters, but also, at best, capable of adjusting the controller of individual functional groups of the slicing machine based on the detected product parameters.

### SUMMARY

The disclosure provides a slicing machine, in particular a slicer, which can remedy this situation, in particular by ensuring comprehensive quality assurance. The disclosure further provides a corresponding method for operating a slicing machine.

A generic slicing machine, such as a slicer, for slicing calibres, preferably a plurality of calibres lying parallel side by side in different tracks, into slices and for storing the slices in shingled or stacked portions typically comprises:
a slicing unit with a preferably rotating knife, usually a sickle knife, whose cutting edge on the outer circumference increases in its distance from the centre of rotation against the direction of rotation, direction,
a feeding unit for feeding at least one calibre to the slicing unit along a feeding
a discharge unit with at least one portioning unit, preferably a portioning belt, for conveying the slices or portions in the direction of travel of the machine,
a gripper which can be moved along the feed direction and
between an engagement position in which it holds the product calibre, and
a release position in which it does not hold the product calibre, and
a controller for controlling moving parts of the slicing machine.

According to the disclosure:
the gripper further comprises a product parameter detection apparatus designed and intended to detect at least one product parameter of the calibre of product held by the gripper, and
the product parameter detection apparatus is in signal connection or configured to communicate with a product parameter analysis apparatus located on or remote from the slicing machine, which is configured to store product parameters detected by the product parameter detection apparatus and/or to process them into a processing result.

It is to the inventor's credit to have recognised that it is particularly advantageous to arrange the product parameter detection apparatus on the gripper itself, since the gripper is in any case regularly engaged with the respective calibre of product to be held. This means that there is no need to configure a separate measuring apparatus away from the gripper, which would first have to ensure suitable accessibility or reachability of the product calibre.

Since the product parameter detection apparatus is further in signal connection or configured to communicate with the product parameter analysis apparatus according to the disclosure, it is furthermore also possible not only to monitor the at least one detected product parameter, but also to store it and/or to process it to a processing result.

The product parameter analysis apparatus can generate the processing result, in particular a log, for quality assurance on the basis of the product parameters detected by the product parameter detection apparatus. Simply storing the at least one recorded product parameter, in particular in the form of a plurality of measured values over a predetermined period of time, makes it possible to check whether the respective product parameter is or was always within a predetermined, for example permissible or desired, area during operation of the slicing machine.

Also, the processing result itself may be such that it directly indicates, in the form of a status message via a user interface of the slicing machine, whether or not the at least one product parameter is in the predetermined area and/or has been in the predetermined area during a predetermined time period. Further, the processing result can indicate whether the state of the slicing machine itself is to be classified as OK or not OK, if maintenance or other corrective measures are to be performed on the slicing machine.

The product parameter analysis apparatus can, for example, be integrated into the controller of the slicing machine or be arranged remotely from it. In the latter case, the product parameter analysis apparatus can consequently be connected by wire or wirelessly to the controller and/or the product parameter detection apparatus.

In accordance with a preferred embodiment, the product parameter detection apparatus may be configured to detect a temperature of the product calibre. As a result, the temperature of the product calibre during the slicing process can be monitored and/or stored in the form of a temperature log as the processing result by the product parameter analysis apparatus. From such a log, it is therefore possible to see whether or not a cold chain has been maintained during the entire slicing process.

Additionally or alternatively, the product parameter detection apparatus may be configured to provide a consistency of product calibre and/or to detect vibrations and/or shocks impacting on the product calibre.

As a consequence, it is also possible to monitor these product parameters in an analogous manner and/or store them in the form of a log or similar. Monitoring the product consistency, for example, allows conclusions to be drawn as to whether the product calibre has a required composition.

The required composition may deviate in particular if a recipe for manufacturing the product calibre has not been followed as required. The deviation can therefore be detected before the actual slicing of the slice begins.

The vibrations and/or shocks impacting on the product calibre in turn indicate whether the cutting process meets predetermined requirements, as a “gentle cutting process” is usually to be ensured in order to guarantee a desired product quality. Further, the vibrations and/or shocks can be used to detect whether or not the slicing machine, in particular the knife of the slicing unit or cutting unit, requires maintenance, for example due to insufficient sharpness.

In accordance with a further exemplary embodiment, the product parameter detection apparatus may comprise a sensing element which is arranged on the gripper in such a manner that, when the product calibre is held, it is in direct or indirect contact with the product calibre, particularly at its end facing the gripper. Indirect contact can take place via an intermediate element that is in direct contact with the product calibre. This is fulfilled, for example, if the sensing element is integrated into an intermediate element that is in contact with the product calibre. Direct contact, on the other hand, should be understood to mean that the sensing element is in direct contact with the product calibre without the presence of an intermediate element. The direct contact can therefore be, for example, but does not necessarily have to be, a contact between the sensing element and the product calibre.

In a further embodiment of this exemplary embodiment, the sensing element may be designed and determined to penetrate the product calibre at least and/or at most to a predetermined depth when the product calibre is held.

If, for example, at least partially frozen product calibres are cut open, it is conceivable that the product calibres is only frozen in the outer area, for example only a few cm or mm, particularly a maximum of 2 cm deep. Then it is desirable that the sensing element also only penetrates this outer area, for example, if the temperature of the outer area is to be detected as the product parameter. If, on the other hand, a core temperature of the product parameter is to be detected, it is correspondingly advantageous if the predetermined depth is selected to be correspondingly greater.

Further, the sensing element may be designed as a force sensor configured to output a force signal indicating a force impacting the force sensor.

If, for example, the sensing element is designed and extended to penetrate the product calibre to at least and/or at most the predetermined depth as described above, it is possible as a consequence to obtain from the force signal a force-displacement curve which indicates the force impacting on the force sensor as a function of a displacement, for example the depth of penetration into the product calibre. This makes it possible, for example, to determine the frost thickness of the product calibre via the force-displacement curve.

Here, a predetermined first force may indicate the thickness of the area of the product calibre that is frozen, while a predetermined second force, which is less than the first force, may indicate the thickness of the area of the product calibre that is not frozen.

In accordance with an exemplary embodiment, the sensing element may be designed as or comprise a needle. The needle can therefore be used as a temperature sensor and/or to detect vibrations and/or shocks and/or the consistency of the product. For this purpose, the needle can be brought into contact with the product calibre, depending on the product parameter to be detected.

The sensing element in the form of a needle is particularly advantageous if, as mentioned above, the sensing element is to penetrate the product calibre, as this enables reliable detection of the product parameter without causing unacceptable damage to the product calibre.

Additionally or alternatively, the sensing element can be arranged on or in a gripper claw of the gripper. This proves to be advantageous if only because the gripper claws of the gripper engage with the product calibre in the gripper engagement position anyway to hold it. Such an arrangement of the sensing element thus proves to be particularly compact, as no separate measuring point for the sensing element needs to be configured on the gripper away from the gripper tines.

In further development of this exemplary embodiment, it is particularly advantageous if the gripping claw is designed to be at least partially hollow and the sensing element is inserted into the at least partially hollow gripping claw. In particular, it is conceivable that the sensing element is only in indirect contact with the product calibre, i.e. the sensing element does not touch the product calibre directly, but only the gripper claw. Consequently, conclusions can be drawn about the corresponding product parameter of the product calibre, for example, via a temperature of the gripper claw or via vibrations or shocks impacting on the gripper claw. The sensing element can be, for example, a sensing wire by means of which the temperature can be detected. The gripper can then also preferably be designed as a cast part. In such a case, a separate work step for forming a corresponding hollow bore can be omitted.

In accordance with a further exemplary embodiment, the product parameter analysis apparatus is further in signal connection or configured to communicate with or integrated into the controller, wherein preferably the controller may further be configured to adjust at least one control parameter of the slicing machine based on the processing result of the product parameter analysis apparatus. Consequently, it is conceivable to forward the product parameters recorded during the slicing process or the processing result derived from them directly to further functional groups of the slicing machine in order to adapt them to the current product parameters.

The at least one control parameter can preferably comprise a control parameter for the feeding unit and/or the slicing unit and/or the discharge unit and/or the gripper of the slicing machine. As a result, for example, a belt speed of a portioning belt of the discharge unit and/or a contact pressure of an upper and/or a lower product guide of the feeding unit and/or a number of cuts per minute by the slicing unit can be adapted to the detected product parameters.

It should also be added that, particularly in the case of a multi-track slicing machine, there can be a plurality of grippers which can be moved in the feed direction, preferably by means of a common drive unit, which drive unit may comprise a motor and associated gear, wherein each of the plurality of grippers can comprise a respective product parameter detection apparatus.

The grippers, in particular all of them, can be arranged on a common gripper unit, in particular a gripper carriage, which can be moved by means of a drive unit, which drive unit may comprise a motor and associated gear, of the gripper unit.

With regard to the method for operating a slicing machine, in particular a slicer, in particular in accordance with the type described above, the method comprises:
detecting at least one product parameter of the product calibre held by a gripper of the slicing machine, wherein the detection preferably takes place at the gripper itself, and
storing and/or processing the at least one product parameter into a processing result.

It should already be indicated at this point that all the effects and advantages described with regard to the slicing machine according to the disclosure also apply to the method according to the disclosure and vice versa.

Preferably, the at least one product parameter can be detected by penetrating the product calibre by at least or at most a predetermined depth, in particular by means of a sensing element arranged on the gripper, preferably a needle, or a sensing element integrated in a gripper claw of the gripper.

The sensing element can preferably be designed as a force sensor, which is configured to output a force signal indicating a force acting on the force sensor.

Additionally or alternatively, at least one control parameter of the slicing machine may be adjusted based on the processing result, wherein preferably the at least one control parameter may comprise a control parameter for a feeding unit and/or a slicing unit and/or a discharge unit and/or the gripper of the slicing machine.

### BRIEF DESCRIPTION OF THE DRAWINGS

Embodiments in accordance with the disclosure are described in more detail below by way of example. In the figures:

FIGS. 1A and 1B show a known slicing machine in the form of a slicer in accordance with prior art in different perspective views, with the feed belt folded up into the slicing position,

FIG. 2A shows a simplified side view of the slicing machine, loaded with a calibre of product, which is in a first functional position,

FIG. 2B shows a side view in accordance with FIG. 2a, but with the feed belt folded down into the loading position and the product calibre cut open except for a calibre residual piece,

FIG. 3 shows a detailed view of FIG. 2b, but during the dropping of the calibre residual piece, which can no longer be cut open, from the gripper,

FIG. 4 shows a detailed view of a gripper of a slicing machine according to the disclosure, with a product parameter detection apparatus arranged thereon, and

FIG. 4A shows an enlarged detailed view of the gripper in accordance with FIG. 4.

### DETAILED DESCRIPTION

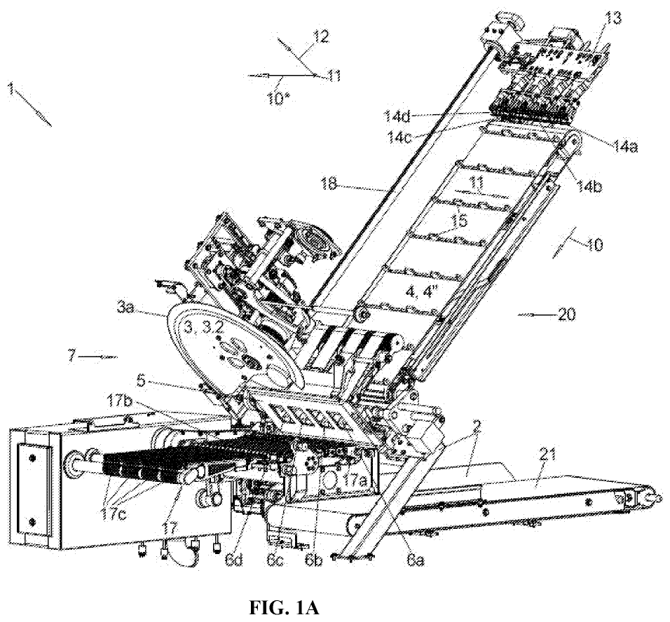

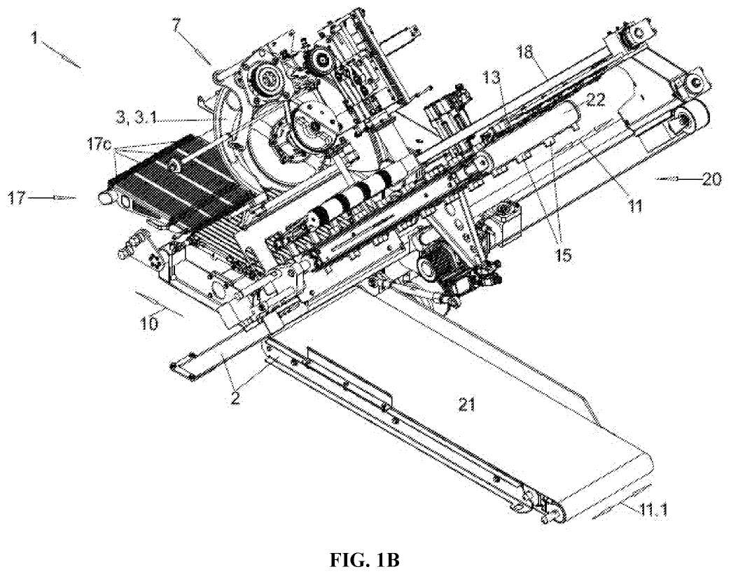

FIGS. 1a, 1b show different perspective views of a multi-track slicer 1 for simultaneously slicing a plurality of product calibres K—which are not represented for reasons of clarity—on one track SP1 to SP4 next to each other and storing them in shingled portions P each consisting of several slices S with a general direction of travel 10* through the slicer 1 from right to left.

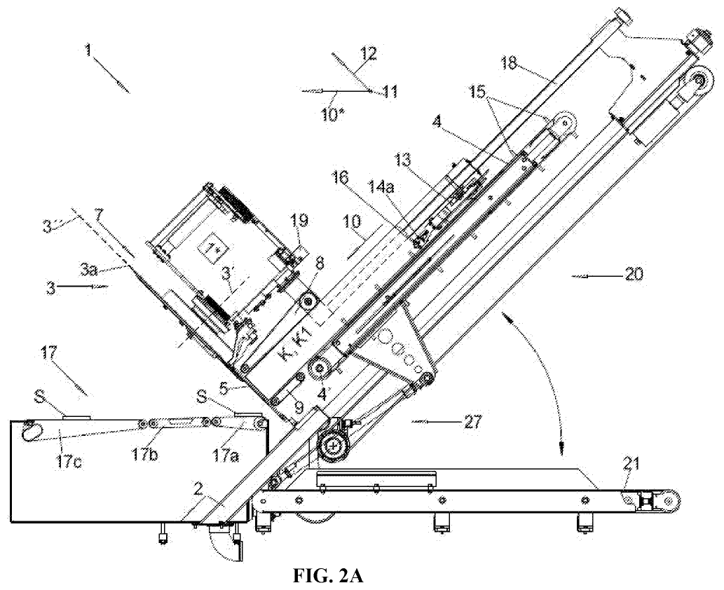

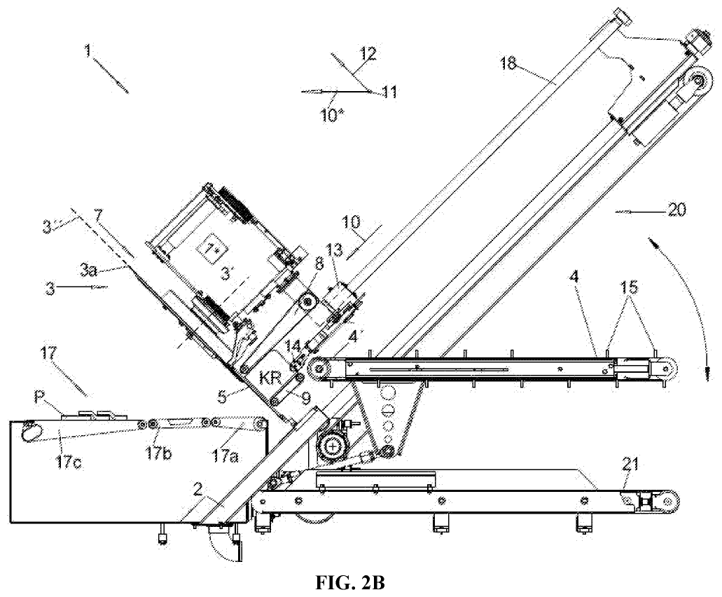

FIG. 2a and FIG. 2b show—with the calibre K inserted—a side view of this slicer 1, omitting covers and other parts not relevant to the disclosure, which are attached to the base frame 2 in the same manner as all other units, so that the functional parts, particularly the conveyor belts, can be seen more clearly. The longitudinal direction 10 is the feed direction of the calibres K to the slicing unit or cutting unit 7 and thus also the longitudinal direction of the calibres K lying in the slicer 1.

It can be seen that the basic structure of a slicer 1 according to the prior art is that a slicing unit 7 with a knife 3 rotating about a knife axis 3″, in this case a sickle knife 3, is fed with several, in this case four, product calibres K lying transversely to the feed direction 10 next to one another on a feed conveyor 4 with spacers 15 of the feed conveyor 4 between them are fed by this feeding unit 20, from the front ends of which the rotating knife 3 cuts off a slice S with its cutting edge 3a in each case in one operation, that is to say almost simultaneously.

For slicing the product calibres K, the feed conveyor 4 is in the slicing position shown in FIGS. 1a-2a, which is oblique in side view with a low-lying front end on the slicing side and a high-lying rear end, from which it can be folded down about a pivot axis 4′ extending in its width direction, the first transverse direction 11, which is located in the vicinity of the slicing unit 7, into an approximately horizontal loading position as represented in FIG. 2b.

The rear end of each calibre K lying in the feeding unit 20 is held in accordance with FIG. 2a in each case by a gripper 14a-d in a form closure with the aid of gripper claws 16. These grippers 14a-14d, which can be activated and deactivated with regard to the position of the gripper claws 16, are fastened to a common gripper carriage 13, which can be tracked along a gripper guide 18 in the feed direction 10.

In this case, both the feed of the gripper slide 13 and of the feed conveyor 4 can be driven in a controlled manner, wherein, however, the actual feed speed of the calibres K is effected by a likewise controlled driven, so-called upper and lower, driven product guide 8, 9 in the form of circulating belts which engage on the upper side and lower side of the calibres K to be cut open in their front end areas near the slicing unit 7:

The front ends of the calibres K are each guided through a “product opening” 6a-d of a plate-shaped slicing frame 5, wherein the slicing plane 3″ extends directly in front of the front, obliquely downward pointing end face of the slicing frame 5, in which the knife 3 rotates with its slicing edge 3a and thus cuts off the protrusion of the calibres K from the slicing goggles 5 as a slice S. The slicing plane 3″ extends perpendicular to the upper run of the feed conveyor 4 and/or is spanned by the two transverse directions 11, 12 to the feed direction 10.

In this case, the inner circumference of the product openings 6a-d of the cutting edge 3a of the knife 3 serves as a counter cutting edge.

Since both product guides 8, 9 can be driven in a controlled manner, particularly independently of one another and/or possibly separately for each track SP1 to SP4, these determine the—continuous or clocked—feed speed of the calibres K through the slicing frame 5.

The upper product guide 8 is displaceable in the second transverse direction 12—which extends perpendicular to the surface of the upper run of the feed conveyor 4—to adapt to the height H of the calibre K in this direction. Further, at least one of the product guides 8, 9 can be designed to pivot about one of its deflection rollers in order to be able to change the direction of the strand of its guide belt resting against the calibre K to a limited extent.

Below the feed conveyor unit 20 there is usually an approximately horizontally extending residue conveyor 21, which starts with its front end below the cutting frames 5 and directly below or behind the discharge unit 17 and with its upper run thereon—by means of the drive of one of the discharge conveyors 17 against the direction of travel 10—transports away falling residues to the rear.

The slices S, which are at an angle in the room when they are separated, fall onto a discharge unit 17 which starts below the cutting goggles 5 and extends in the direction of travel 10*, which in this case consists of a plurality of discharge units 17a, b, c arranged one behind the other with their upper runs approximately aligned in the direction of travel 10*, of which the first discharge unit 17a in the direction of travel 10 can be designed as a portioning belt 17a and/or one can also be designed as a weighing unit.

The slices S can arrive at the discharge unit 17 individually and at a distance from one another in the general direction of travel 10* of the products through the machine or, by appropriate control of the portioning belt 17a of the discharge unit 17—the movement of which, like almost all moving parts, is controlled by the controller 1*—form shingled or stacked portions P by stepwise forward movement of the portioning belt 17a.

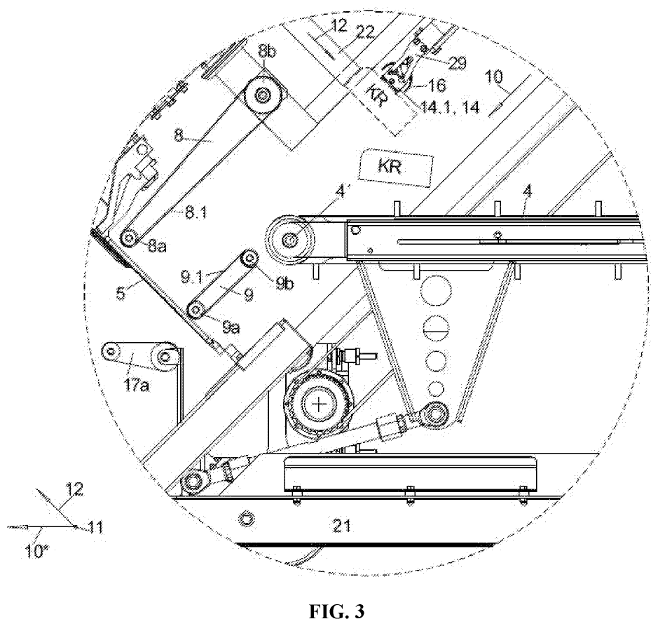

FIG. 3 shows a detailed view of FIG. 2b, in which in particular the upper product guide 8, the lower product guide 9, the feed conveyor 4 as well as the gripper 14 can be better recognised. The representation shows the gripper 14 with the calibre residual piece KR still indicated on it in a position retracted from the cutting frame 5, in which the calibre remnant KR is just ejected from the gripper 14 by releasing the gripper claws 16.

The gripper claws 16 are attached to a gripper base body 29 of the gripper 14 in a movable manner, i.e. movable between an engagement position and a release position.

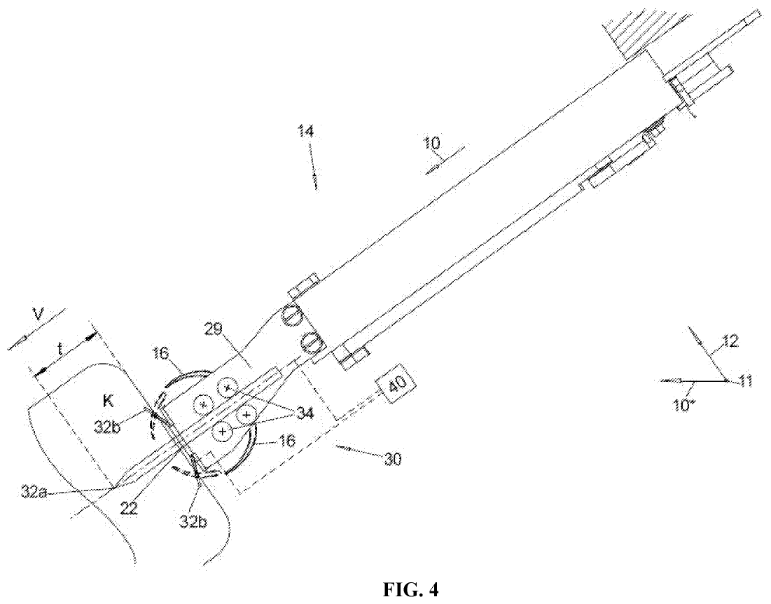

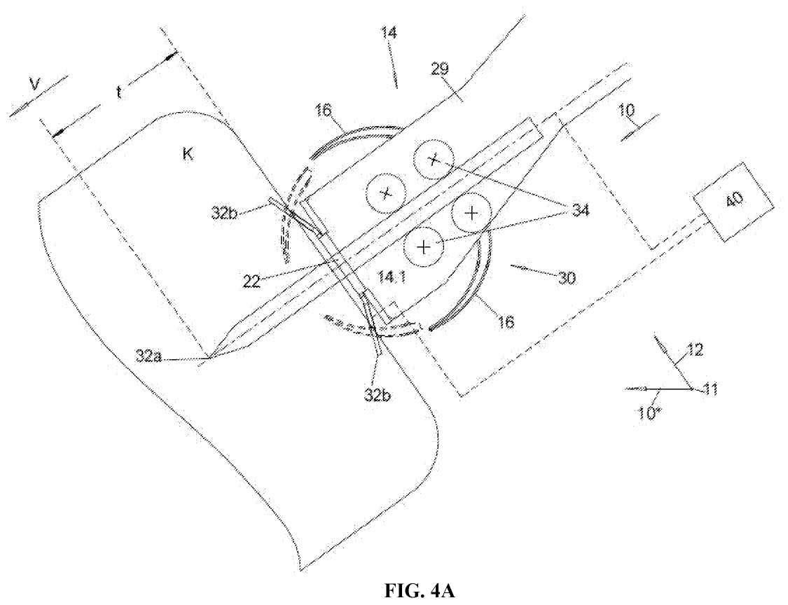

FIG. 4 and FIG. 4a show the gripper 14 of a slicing machine 1 according to the disclosure, with a product parameter detection apparatus 30 arranged thereon. The product parameter detection apparatus 30 is designed and intended to detect at least one product parameter of the product calibre K held by the gripper 14 by means of the gripper claws 16.

In FIGS. 4 and 4a the engagement position of the gripper 14, in which it holds the product calibre K is shown with dashed lines of the gripper claws 16. By opening, i.e. by retracting, the gripper claws 16, the gripper 14 can be transferred to the release position (solid lines of the gripper claws 16), in which it does not hold the product calibre K, so that the product calibre K can move away from the gripper 14 or be removed from it. To grip a product calibre K again, the gripper claws 16 can again be moved from the release position to the engagement position.

In order to enable the detection of a product parameter, the product parameter detection apparatus 30 may comprise a sensing element 32a, which is designed as a needle 32a that penetrates the product calibre K by at least and/or at most a predetermined depth t when the product calibre K is held.

Additionally or alternatively, the product parameter detection apparatus 30 may comprise at least one further sensing element 32b, which in the exemplary embodiment shown is designed as a contact sensor 32b, which is in direct contact with the end of the product facing the gripper 14 when the product calibre K is held.

If the product parameter detection apparatus 30 comprises, for example, the needle 32a described above, it can be moved out of the base body 29 of the gripper 14 along a feed direction V and into the gripper 14 against the feed direction V by means of a suitable drive apparatus 34.

The sensing element in the form of the needle 32a may be configured to act as a force sensor which is configured to output a force signal indicating a force applied to the force sensor, i.e. the needle 32a. Thus, when the needle 32a extends into the product calibre K along the direction of advance V, it is possible to obtain from the force signal a force-displacement curve which indicates the force acting on the needle 32a as a function of a displacement, for example the depth of penetration t into the product calibre K.

This makes it possible, for example, to determine the frost thickness of the product calibre K via the force-displacement curve. If the calibre is frozen in its outer area, a first, higher force will initially be required and measured for penetration through the frozen area, while further penetration into the non-frozen inner area will only require a second, lower force, which is less than the first force.

In order to be able to analyse the product parameters detected by the product parameter detection apparatus 30, i.e. to store them and/or to process them into a processing result, the product parameter detection apparatus 30, in particular the needle 32a and/or the contact sensor 32b, is in signal connection or configured to communicate with a product parameter analysis apparatus 40, which is only schematically represented in FIGS. 4 and 4a. The product parameter analysis apparatus 40 can further be in signal connection or configured to communicate with the controller 1* or also integrated into it. In that regard, as one skilled in the art would understand, the controller 1* and the product parameter analysis apparatus 40, as well an any other unit, machine, apparatus, element, sensor, device, component, system, subsystem, arrangement, or the like described herein may individually, collectively, or in any combination comprise appropriate circuitry, such as one or more appropriately programmed processors (e.g., one or more microprocessors including central processing units (CPU)) and associated memory, which may include stored operating system software and/or application software executable by the processor(s) for controlling operation thereof and/or for performing the particular algorithms represented by the various functions and/or operations described herein, including interaction and/or cooperation between any such controller, unit, machine, apparatus, element, sensor, device, component, system, subsystem, arrangement, or the like. One or more of such processors, as well as other circuitry and/or hardware, may be included in a single ASIC (Application-Specific Integrated Circuitry), or several processors and various circuitry and/or hardware may be distributed among several separate components, whether individually packaged or assembled into a SoC (System-on-a-Chip).

The product parameter analysis apparatus 40 can thereby generate the processing result on the basis of the product parameters detected by the product parameter detection apparatus 30, in particular generate a log for quality assurance. Simply storing the at least one recorded product parameter, in particular in the form of a plurality of measured values over a predetermined period of time, makes it possible to check whether the respective product parameter, for example the temperature of the product calibre K, is or has always been within a predetermined, for example permissible or desired, area during operation of the slicing machine 1.

Further, the controller 1* may be configured to adjust at least one control parameter of the slicing machine 1 based on the processing result of the product parameter analysis apparatus 40. It is therefore possible to react to the measured product parameters of the product calibre K on the basis of the processing result of the product parameter analysis apparatus 40 and, for example, to adjust a control parameter for the feeding unit 20 and/or the slicing unit 7 and/or the discharge unit 17 and/or the gripper 14.

Provided that the slicing machine 1 comprises a plurality of grippers 14a-d, as represented in FIG. 1a, b, each of the grippers 14a-d may comprise a product parameter detection apparatus 30 according to the disclosure, each of which is in signal connection or configured to communicate with the product parameter analysis apparatus 40. This means that the product parameters of the K calibres of all tracks SP1 to SP4 can be monitored and analysed accordingly.

### LIST OF REFERENCE NUMBERS

1 Slicing machine, slicer
1* Controller
2 Base frame
3 Knife
3 Axis of rotation
3″ Knife plane, slicing plane
3a Slicing edge
4 Feed conveyor, feed belt
5 Slicing goggles
6a-d Goggle opening
7 Slicing unit
8 Upper product guide, upper guide belt
8.1 Contact run, lower run
8a Goggle-side pulley
8b Goggle-averted pulley
9 Lower product guide, lower guide belt
8.1 Contact run, upper run
9a Goggle-side pulley
9b Goggle-averted pulley
10 Transport direction, longitudinal direction, axial direction
10* Direction of passage through machine
11 1. Transverse direction (width slicer)
12 2. Transverse direction (height-direction calibre)
13 Gripper unit, gripper slide
14,14a-d Gripper
15 Spacer
16 Gripper claw
17 Discharge unit
17a, b, c Discharge conveyor
17a Portioning belt
18 Gripper guide
19 Height sensor
20 Feeding unit
21 Residual piece conveyor
22 Residual piece remover
29 Gripper base body
30 Product parameter detection apparatus
32a, 32b Sensing element, needle, contact sensor
40 Product parameter analysis apparatus
K Product, product calibre
KR Residual piece
S Slice
T Release agent
P Portion
V Feed direction
t Penetration depth

What is claimed is:

1. A slicing machine for slicing a calibre of product into slices and producing shingled or stacked portions from the slices, the slicing machine comprising:
a slicing unit,
a feeding unit for feeding at least one calibre to the slicing unit along a feeding direction,
a discharge unit with at least one portioning unit for discharging the slices or portions in a direction of travel of the slicing machine,
a gripper moveable along the feeding direction and
between an engagement position in which the gripper holds the product calibre, and
a release position in which the gripper does not hold the product calibre,
a controller for controlling moving parts of the slicing machine,
wherein
the gripper comprises a product parameter detection apparatus configured to determine at least one product parameter of the product calibre held by the gripper, and
the product parameter detection apparatus is configured to communicate with a product parameter analysis apparatus arranged at or remote from the slicing machine, the product parameter analyses apparatus configured to store product parameters detected by the product parameter detection apparatus and/or to process them into a processing result.

2. The slicing machine according to claim 1, wherein the product parameter detection apparatus is configured to detect a temperature of the product calibre.

3. The slicing machine according to claim 1, wherein the product parameter detection apparatus is configured to detect a consistency of the product calibre and/or vibrations and/or impacts acting on the product calibre.

4. The slicing machine according to claim 1, wherein the product parameter detection apparatus comprises a sensing element which is arranged on the gripper in direct or indirect contact with the product calibre.

5. The slicing machine according to claim 4, wherein the sensing element is configured to penetrate the product calibre by at least and/or at most a predetermined depth when the product calibre is held.

6. The slicing machine according to claim 4, wherein the sensing element comprises a force sensor configured to output a force signal indicative of a force acting on the force sensor.

7. The slicing machine according to claim 4, wherein the sensing element is a needle or comprises a needle.

8. The slicing machine according to claim 4, wherein the sensing element is arranged on or in a gripper claw of the gripper.

9. The slicing machine according to claim 8, wherein the gripper claw is at least partially hollow and the sensing element is inserted into the at least partially hollow gripper claw.

10. The slicing machine according to claim 1, wherein the product parameter analysis apparatus is configured to communicate with or is integrated into the controller, and wherein the controller is further configured to adjust at least one control parameter of the slicing machine based on the processing result of the product parameter analysis apparatus.

11. The slicing machine according to claim 10, wherein the at least one control parameter comprises a control parameter for the feeding unit and/or the slicing unit and/or the discharge unit and/or the gripper.

12. The slicing machine according to claim 1, wherein the gripper comprises a plurality of grippers, each moveable in the feed direction, wherein each of the plurality of grippers comprises a product parameter detection apparatus.

13. The slicing machine according to claim 12, wherein all of the plurality of grippers are arranged on a common gripper unit, the common gripper unit moveable by a drive unit.

14. A method of operating a slicing machine for slicing a calibre of product into slices and producing shingled or stacked portions from the slices, the method comprising:
detecting at least one product parameter of the product calibre held by a gripper of the slicing machine; and
storing and/or processing the at least one product parameter into a processing result.

15. The method according to claim 14, wherein the at least one product parameter is detected by penetrating the product calibre by at least and/or at most a predetermined depth, by a sensing element arranged on the gripper, or a sensing element integrated into a gripper claw of the gripper, wherein the sensing element comprises a force sensor configured to output a force signal indicative of a force acting on the force sensor.

16. The method according to claim 14, wherein at least one control parameter of the slicing machine is adjusted based on the processing result, wherein the at least one control parameter comprises a control parameter for a feeding unit and/or a slicing unit and/or a discharge unit and/or the gripper of the slicing machine.

17. A slicing machine for slicing a calibre of product into slices and producing shingled or stacked portions from the slices, the slicing machine comprising:
a slicing unit;
a feeding unit for feeding at least one calibre to the slicing unit along a feeding direction;
a discharge unit for discharging the slices or portions in a direction of travel of the slicing machine; and
a gripper moveable along the feeding direction and between an engagement position in which the gripper holds the product calibre and a release position in which the gripper does not hold the product calibre;
wherein the gripper comprises a product parameter detection apparatus configured to determine at least one product parameter of the product calibre held by the gripper, and wherein the product parameter detection apparatus is configured to communicate with a product parameter analysis apparatus configured to store product parameters detected by the product parameter detection apparatus and/or to process them into a processing result.

18. The slicing machine according to claim 17 further comprising a controller for controlling moving parts of the slicing machine, wherein the moving parts of the slicing machine comprise at least one of the slicing unit, the feeding unit, the discharge unit, and the gripper.

19. The slicing machine according to claim 18 wherein the product parameter apparatus is arranged at the slicing machine.

20. The slicing machine according to claim 17 wherein the product parameter apparatus is arranged remote from the slicing machine.
